(19) United States
(12) Patent Application Publication
(10) Pub. No.: US 2010/0120592 A1
(43) Pub. Date: May 13, 2010

(54) MACHINE ROLLER

(76) Inventor: Yu-Lang WU, Sinjhuang City (TW)

Correspondence Address: Muncy, Geissler, Olds & Lowe, PLLC, P.O. BOX 1364, FAIRFAX, VA, 22038-1364, US

(21) Appl. No.: 12/266,996

(22) Filed: Nov. 7, 2008

(51) Int. Cl. F16C 13/00

(52) U.S. Cl. 492/16

(57) ABSTRACT

A machine roller includes a core shaft having an inner hollow space and two opposite open ends communicating with the inner hollow space; and two support axles separately connected to the two open ends of the core shaft. The two support axles are connected to the core shaft by radio-frequency heating the core shaft and then extending the support axles into the inner hollow space via the two open ends. Therefore, the machine roller can reduce weight and be easily manufactured to enable decreased manufacturing cost thereof.

### FIELD OF THE INVENTION

The present invention relates to a machine roller, and more particularly to a machine roller that can reduce weight and be manufactured easily, and reduce manufacturing cost.

### BACKGROUND OF THE INVENTION

Generally, a conventional roller for using in office machines, exercise equipment and machines, and different roller mechanisms is a metal shaft. The conventional roller is manufactured by cutting the metal shaft according to the machine on which the roller is to be used, so as to form a central core shaft and two support axles integrally connected to two ends of the central core shaft. The roller can be used in various machines, such as printers, copiers, facsimile machines, scanners, laminators, barcode printers, banknote counters, banknote detectors, automated teller machines, running machines, swing machines, belt conveyors, etc.

While the conventional roller can be used in various office machines, exercise machines, and roller mechanisms, it is uneasy to manufacture the conventional roller, which is formed by cutting a metal shaft to include a central core shaft and two support axles integrally formed at two ends of the central core shaft. Moreover, the metal-made roller requires higher manufacturing cost and is relatively heavy. In practical use of the conventional metal roller, the high weight thereof tends to cause unsmooth operation of or even damage to the machine after a long period of time. Therefore, the conventional integrally formed metal roller is not practical for use in terms of its difficult manufacturing process, heavy weight, and high manufacturing cost.

### SUMMARY OF THE INVENTION

A primary object of the present invention is to provide a machine roller that can be manufactured easily and reduce weight to enable decreased manufacturing cost thereof.

To achieve the above and other objects, the machine roller according to the present invention includes a core shaft having an inner hollow space and two opposite open ends communicating with the inner hollow space; and two support axles separately connected to the two open ends of the core shaft. The two support axles are connected to the core shaft by radio-frequency heating the core shaft and then extending the support axles into the inner hollow space via the two open ends.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a machine roller according to a first embodiment of the present invention;

FIG. 2 is an assembled view of FIG. 1;

FIG. 3 is a longitudinal sectional view of FIG. 2;

FIG. 4 is an exploded perspective view of a machine roller according to a second embodiment of the present invention;

FIG. 5 is an assembled view of FIG. 4; and

FIG. 6 is a longitudinal sectional view of FIG. 5.

### DETAILED DESCRIPTION OF THE PREFERRED EMBODIMENTS

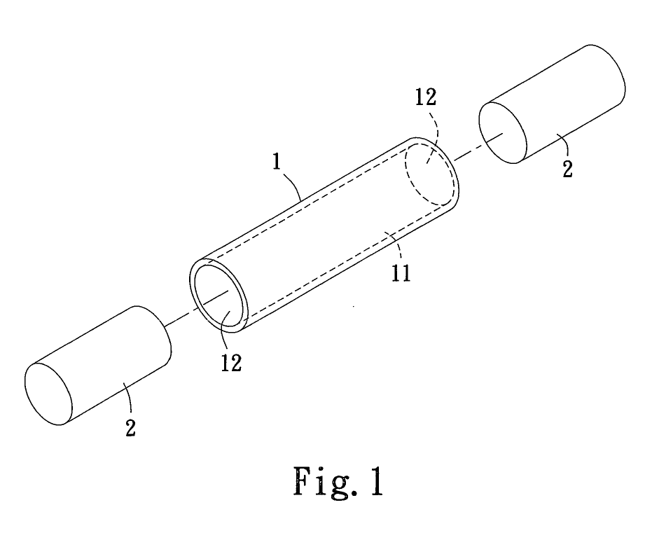

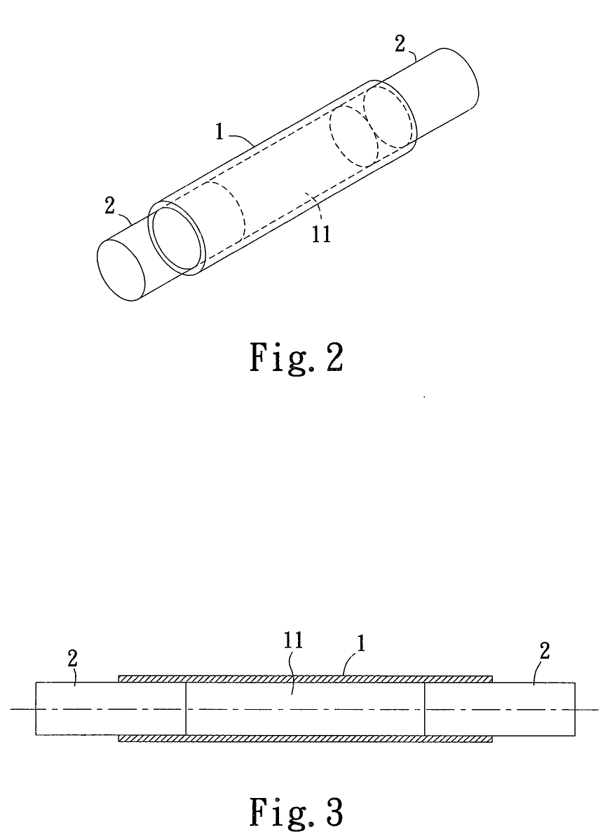

Please refer to FIGS. 1 and 2 that are exploded and assembled perspective views, respectively, of a machine roller according to a first embodiment of the present invention, and to FIG. 3 that is a longitudinal sectional view of FIG. 2. As shown, the machine roller in the first embodiment includes at least a core shaft 1 and two support axles 2.

The core shaft 1 defines an inner hollow space 11, and has two opposite open ends 12 communicating with the inner hollow space 11. The core shaft 1 can be a seam tube or a seamless tube.

The support axles 2 are separately connected to the two open ends 12 of the core shaft 1. The support axles 2 each can be a solid cylindrical member, a hollow cylindrical member, or a stepped cylindrical member.

In manufacturing the machine roller of the present invention, the core shaft 1 is heated by radio-frequency waves for a preset time or to a required temperature. Then, the two support axles 2 are separately extended into the two open ends 12 of the core shaft 1, such that each of the two support axles 2 has a predetermined portion received in the inner hollow space 11 with the remaining portion projected from the corresponding open end 12. When the core shaft 1 has become cooled and accordingly contracted, the two support axles 2 are naturally firmly held to the two open ends 12 of the core shaft 1. In this manner, the machine roller can be easily manufactured and reduce weight to enable decreased manufacturing cost thereof.

Moreover, since the core shaft 1 and the two support axles 2 are connected to one another by way of radio-frequency heating, the core shaft 1 and the support axles 2 can be made of similar or different materials, depending on the machine on which the roller is to be used. Therefore, the machine roller of the present invention can be widely applied to various office machines, exercise equipment and machines, and roller mechanisms, such as printers, copiers, facsimile machines, scanners, laminators, barcode printers, banknote counters, banknote detectors, automated teller machines (ATM), running machines, swing machines, belt conveyors, etc.

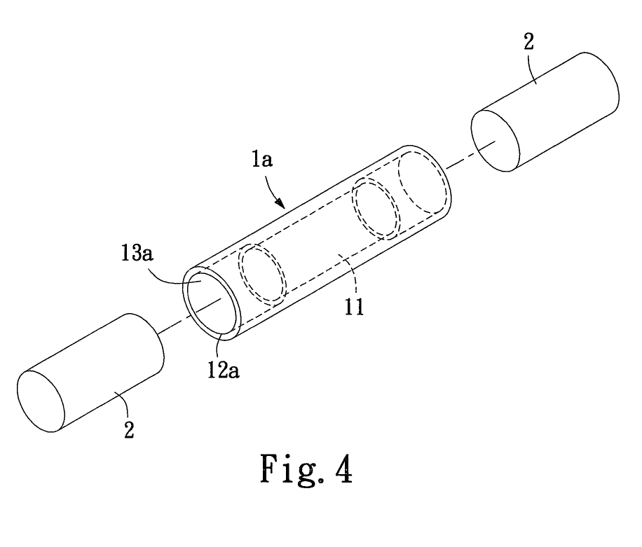

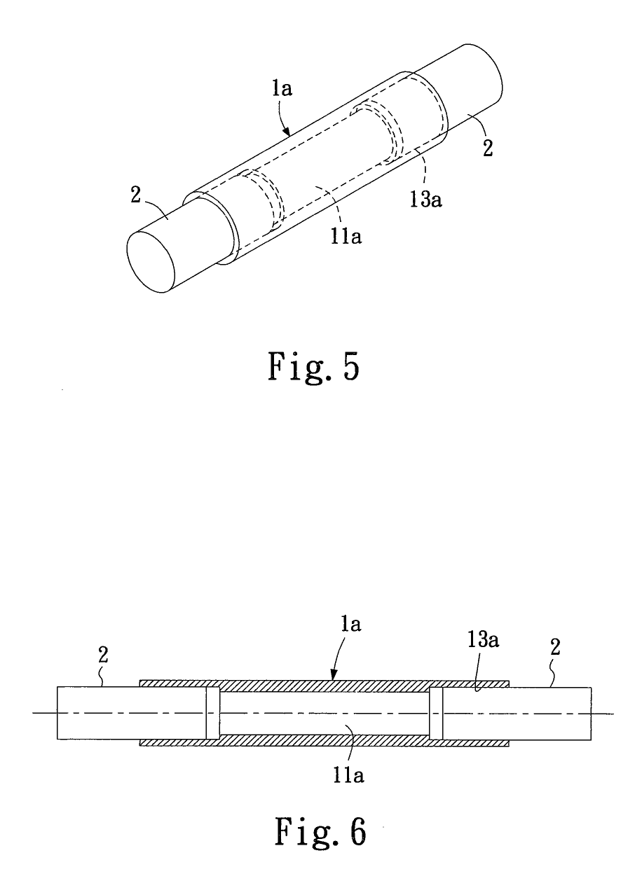

FIGS. 4 and 5 are exploded and assembled perspective views, respectively, of a machine roller according to a second embodiment of the present invention, and FIG. 6 is a longitudinal sectional view of FIG. 5. The machine roller in the second embodiment is generally structurally similar to the first embodiment except for a core shaft 1a having a stepped inner hollow space 11a. As can be seen from FIGS. 4, 5, and 6, the core shaft 1a has an inner hollow space 11a and two opposite open ends 12a communicating with the inner hollow space 11a. The inner hollow space 11a includes a radially expanded section 13a inward extended from each of the open ends 12a by a predetermined length, so that a stepped or a shoulder portion is formed between each of the radially expanded sections 13a and the remaining portion of the inner hollow space 11a. The radially expanded sections 13a can be produced to a predetermined diameter. When the two support axles 2 are separately intended into the radially expanded sections 13a via the two open ends 12a of the core shaft 1a, the support axles 2 are stopped by the stepped or shoulder portion from inward moving any further. Therefore, the two support axles 2 are automatically held in the core shaft 1a at two ends thereof by a desired depth. That is, the two support axles 2 each have a predetermined length extended into and held in the radially expanded section 13a with the remaining length of the support axles 2 projected from the open ends 12a of the core shaft 1a. In this manner, the machine roller of the present invention is more practical for use.

In brief, the machine roller of the present invention can effectively improve the conventional roller because it can be easily manufactured and reduce weight to enable decreased manufacturing cost thereof. Therefore, the present invention is improved and more practical for use.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A machine roller, comprising:
a core shaft defining an inner hollow space and having two opposite open ends communicating with the inner hollow space, wherein the core shaft can be a seam tube or a seamless tube; and
two support axles being separately connected to the two open ends of the core shaft by radio-frequency heating the core shaft and then extending the support axles into the inner hollow space via the two open ends, so that the support axles are firmly held to the core shaft when the core shaft becomes cooled.

2. The machine roller as claimed in claim 1, wherein the inner hollow space of the core shaft includes a radially expanded section inward extended from each of the two open ends by a predetermined length.

3. The machine roller as claimed in claim 1, wherein the support axles are selected from the group consisting of solid cylindrical members, hollow cylindrical members, and stepped cylindrical members.
